(19) United States
(12) Patent Application Publication
(10) Pub. No.: US 2026/0045663 A1
(43) Pub. Date: Feb. 12, 2026

(54) INTER-DEVICE CONDUCTION MEMBER

(71) Applicant: Prime Planet Energy & Solutions, Inc., Tokyo (JP)

(72) Inventor: Satoshi FUJIMURA, Toki-shi (JP)

(21) Appl. No.: 19/246,688

(22) Filed: Jun. 24, 2025

(30) Foreign Application Priority Data
Aug. 9, 2024 (JP) 2024-134544

(51) Int. Cl. H01M 50/581; H01M 50/503; H01M 50/522; H01M 50/524

(52) U.S. Cl. CPC H01M 50/581; H01M 50/503; H01M 50/522; H01M 50/524; H01M 2200/101

(57) ABSTRACT

An inter-device conduction member includes a conduction part having a first connecting portion that connects to an electrode terminal of one power storage device, a second connecting portion that connects to an electrode terminal of another power storage device, and an expected breaking portion that is located between the first connecting portion and the second connecting portion and is conductively connected with the first connecting portion and the second connecting portion, and a break inducing part configured to deform upon a temperature rise to a level equal to or higher than an operating temperature to break the expected breaking portion of the conduction part and make connection between the first connecting portion and the second connecting portion non-conductive.

### CROSS-REFERENCE TO RELATED APPLICATIONS

This application is based upon and claims the benefit of priority from the prior Japanese Patent Application No. 2024-134544 filed on Aug. 9, 2024, the entire contents of which are incorporated herein by reference.

### BACKGROUND

### Technical Field

The disclosure relates to an inter-device conduction member that conducts electricity between an electrode terminal of one power storage device (such as a battery or a capacitor) and an electrode terminal of another power storage device.

### Related Art

Hybrid vehicles, plug-in hybrid vehicles, and electric vehicles are equipped with battery packs that contain a large number of batteries. In such battery packs, each battery is provided with a safety valve, a current interrupt device (CID), etc. for improvement of the safety. In the battery pack, electrode terminals of adjacent batteries are conductively connected to each other with a bus bar made of a rectangular metal plate, for example. Examples of the bus bars and battery pack are disclosed in Japanese unexamined patent application publication No. 2024-085447 (JP 2024-085447 A).

### SUMMARY

### Technical Problems

However, it is desirable to further improve the safety of the battery pack. The known bus bar described above is simply a metal plate; therefore, even when the temperature of the bus bar rises to a high level, such as when a large current passes through the bus bar, the bus bar cannot interrupt the current passing through it and cut off electrical connection between the batteries.

The disclosure was made in view of the above situation, and provides an inter-device conduction member that conducts electricity between power storage devices such as batteries, wherein when the temperature of the inter-device conduction member rises to a high level, the inter-device conduction member itself breaks so that electrical connection between the power storage devices conducted via the inter-device conduction member can be cut off.

### Means of Solving the Problems

(1) One aspect of the disclosure for solving the above problem is an inter-device conduction member that conducts electricity between an electrode terminal of a first power storage device and an electrode terminal of a second power storage device. The inter-device conduction member includes a conduction part having a first connecting portion that connects to the electrode terminal of the first power storage device, a second connecting portion that connects to the electrode terminal of the second power storage device, and an expected breaking portion that is located between the first connecting portion and the second connecting portion and is conductively connected with the first connecting portion and the second connecting portion, and a break inducing part configured to deform upon a temperature rise to a level equal to or higher than an operating temperature to break the expected breaking portion of the conduction part and make connection between the first connecting portion and the second connecting portion non-conductive.

In the inter-device conduction member described above, when the temperature of the break inducing part rises to the operating temperature or higher, the break inducing part deforms and breaks the expected breaking portion of the conduction part to make connection between the first connecting portion and the second connecting portion of the conduction part non-conductive. Thus, the inter-device conduction member itself can cut off electrical connection between the power storage devices conducted via the inter-device conduction member.

(2) In the inter-device conduction member described in (1) above, the conduction part may have a first member comprising a first metal and comprising the first connecting portion and a first non-connecting portion other than the first connecting portion, a second member comprising a second metal different from the first metal and comprising the second connecting portion and a second non-connecting portion other than the second connecting portion, and a joint in which a part of the first non-connecting portion and a part of the second non-connecting portion are joined together and are conductively connected with each other.

(3) The inter-device conduction member described in (2) above may further include a resin sealing member that hermetically seals the joint of the conduction part.

(4) In the inter-device conduction member described in (3) above, the first non-connecting portion of the first member may have a first roughened seal surface on which first nanocolumns formed by joining first particles derived from the first metal that forms the first member together like strings of beads into the form of columns and having a height of 50 nm or more stand numerously, and the second non-connecting portion of the second member may have a second roughened seal surface on which second nanocolumns formed by joining second particles derived from the second metal that forms the second member together like strings of beads into the form of columns and having a height of 50 nm or more stand numerously. The resin sealing member may hermetically seal the joint by being hermetically joined to the first roughened seal surface such that a resin material that forms the resin sealing member fills gaps between the first nanocolumns standing numerously on the first roughened seal surface, and by being hermetically joined to the second roughened seal surface such that the resin material fills gaps between the second nanocolumns standing numerously on the second roughened seal surface.

(5) In the inter-device conduction member described in any of (1) to (4) above, the break inducing part may have a bimetal member comprising a bimetal and configured to deform to be reversed with a click upon a temperature rise to a level equal to or higher than the operating temperature, causing the expected breaking portion of the conduction part to break.

(6) In the inter-device conduction member described in any of (1) to (4) above, the break inducing part may have a shape memory alloy member comprising a shape memory alloy and configured to deform upon a temperature rise to a level equal to or higher than the operating temperature that is a transformation point, causing the expected breaking portion of the conduction part to break.

(7) In the inter-device conduction member according to any of (1) to (4) above, the break inducing part may have a temperature-sensitive structure including a fixing member comprising a thermoplastic resin or a low-melting-point metal, and an elastic member held in a compressed state by the fixing member, and the temperature-sensitive structure may be configured to release the elastic member held by the fixing member to break the expected breaking portion of the conduction part upon a temperature rise to a level equal to or higher than the operating temperature that is a softening temperature of the thermoplastic resin or a melting point of the low-melting-point metal.

### BRIEF DESCRIPTION OF THE DRAWINGS

FIG. 1 is a top view of a battery module configured using bus bars according to the first to fourth embodiments;

FIG. 2 is a top view of a bus bar according to the first embodiment;

FIG. 3 is a cross-sectional view of the bus bar according to the first embodiment as seen in the direction of arrows in FIG. 2;

FIG. 4 is an enlarged cross-sectional view of a break inducing part, a resin sealing member, and its vicinities in FIG. 3, of the bus bar according to the first embodiment;

FIG. 5 is an explanatory view of the bus bar according to the first embodiment, showing an enlarged view of the junction between a first roughened seal surface of a first member (or a second roughened seal surface of a second member) and the resin sealing member;

FIG. 6 is an explanatory view according to the first embodiment, showing how the break inducing part deforms upon a temperature rise and breaks an expected breaking portion of the conduction part;

FIG. 7 is an explanatory view in connection with a method of manufacturing the bus bar according to the first embodiment, showing the manner of forming a plurality of first bowl-shaped recesses and first nanocolumns standing numerously on each first bowl-shaped recess (or a plurality of second bowl-shaped recesses and second nanocolumns standing numerously on each second bowl-shaped recess), on a first seal portion of the first member (or a second seal portion of the second member) through scanning with a pulsed laser beam;

FIG. 8 is an enlarged cross-sectional view corresponding to FIG. 4, of a bus bar according to a second embodiment;

FIG. 9 is an explanatory view corresponding to FIG. 6, of the bus bar according to the second embodiment;

FIG. 10 is an enlarged cross-sectional view corresponding to FIG. 4, of a bus bar according to a third embodiment;

FIG. 11 is an explanatory view corresponding to FIG. 6, of the bus bar according to the third embodiment;

FIG. 12 is an enlarged cross-sectional view corresponding to FIG. 4, of a bus bar according to a fourth embodiment; and

FIG. 13 is an explanatory view corresponding to FIG. 6, of the bus bar according to the fourth embodiment.

### DETAILED DESCRIPTION OF THE EXEMPLARY EMBODIMENTS

### First Embodiment

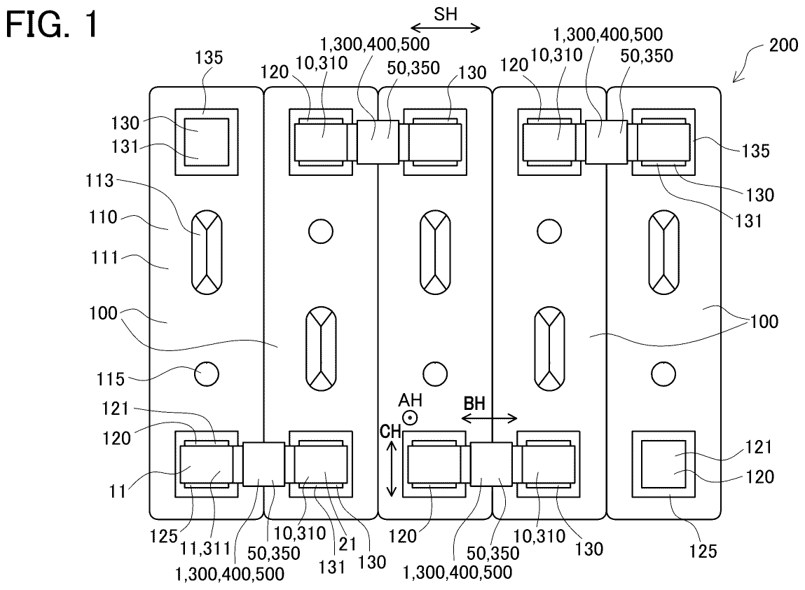

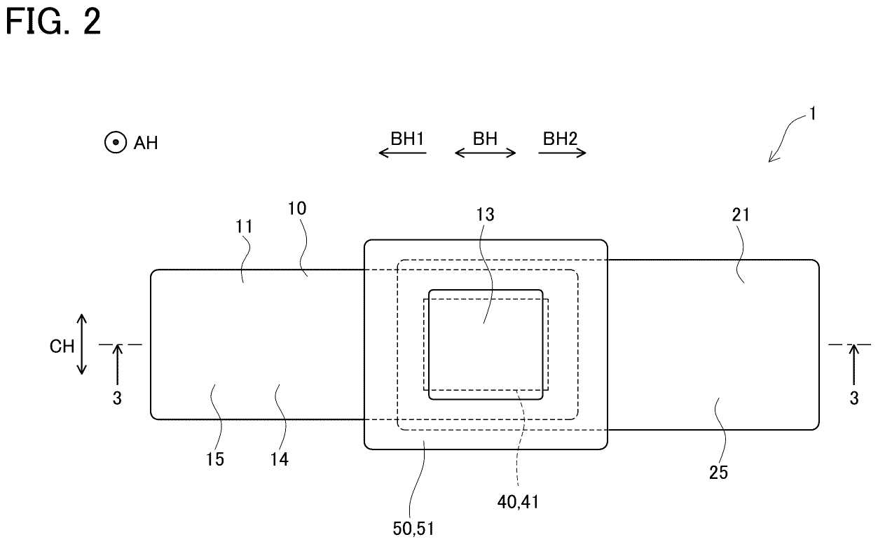

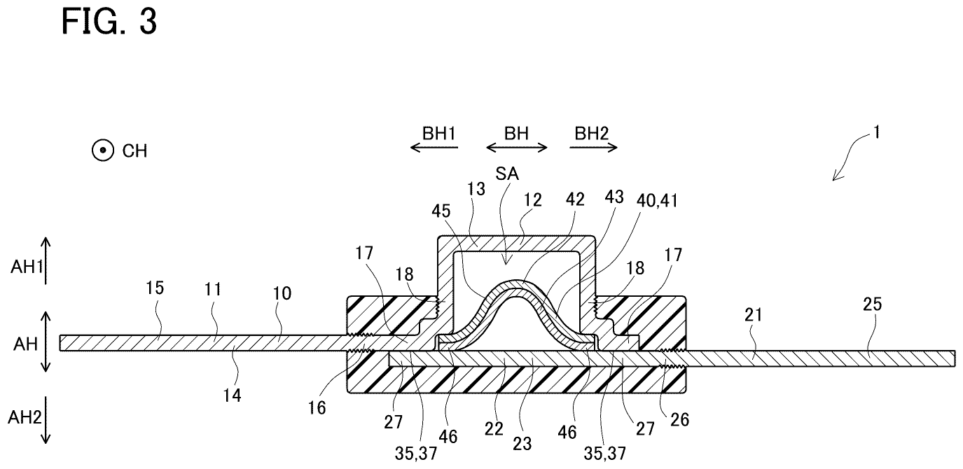

A first embodiment of the disclosure will be described below with reference to the drawings. A bus bar (one example of the inter-device conduction member of the disclosure) 1 (see FIG. 1 to FIG. 5) of the first embodiment is a member that conducts electricity between adjacent rectangular (rectangular parallelepiped) batteries (power storage devices) 100 in a battery module 200 (see FIG. 1) installed in a vehicle, such as a hybrid vehicle, a plug-in hybrid vehicle, or an electric vehicle. In the following description, the height direction AH, long-side direction BH, and short-side direction CH of the bus bar 1 are defined as the directions indicated in FIG. 1 to FIG. 5.

The battery module 200 has a plurality of batteries 100 (see FIG. 1). The batteries 100 that constitute the battery module 200, which are alternately oriented and stacked in a row in the battery thickness direction, are housed in a module case that is not shown and are constrained in the battery stacking direction SH by the module case. A positive terminal (electrode terminal) 120 of one of two adjacent batteries 100 and a negative terminal (electrode terminal) 130 of the other battery 100 are arranged in the battery stacking direction SH and are electrically connected (series connected) via a bus bar 1. The bus bar 1 is joined by welding to the positive terminal 120 and the negative terminal 130, respectively.

Each battery 100 consists of a case 110 in the form of a rectangular box, an electrode body (not shown) including positive and negative electrode plates and electrolyte (not shown) housed in the case 110, the positive terminal 120 and negative terminal 130 respectively supported by the case 110, and so forth. An upper wall 111 of the case 110 is provided with a safety valve 113 that breaks and opens when the internal pressure of the case 110 exceeds the valve opening pressure. The upper wall 111 of the case 110 is also provided with a liquid inlet (not shown), which is hermetically sealed by a disc-shaped sealing member 115.

The positive terminal 120 and the negative terminal 130 are fixed to the upper wall 111 of the case 110. Specifically, a pair of insertion holes (not shown) is provided in the upper wall 111 of the case 110, and the positive terminal 120 made of a first metal (aluminum in the first embodiment) is inserted in one of the insertion holes, while the negative terminal 130 made of a second metal (copper in the first embodiment) different from the first metal is inserted in the other insertion hole. The positive terminal 120 is fixed to the upper wall 111 of the case 110 via an insert-molded resin insulating member 125, and the negative terminal 130 is fixed to the upper wall 111 of the case 110 via an insert-molded resin insulating member 135. The positive terminal 120 has a rectangular positive electrode top plate 121 located outside the case 110, and the bus bar 1 is welded to the positive electrode top plate 121. The positive terminal 120 is conductively connected to a positive current collector of the electrode body in the case 110. The negative terminal 130 has a rectangular negative electrode top plate 131 located outside the case 110, and the bus bar 1 is welded to the negative electrode top plate 131. The negative terminal 130 is conductively connected to a negative current collector of the electrode body in the case 110.

Next, the bus bar 1 will be described (see FIG. 1 to FIG. 5). The bus bar 1 consists of a conduction part 10 that conducts electricity between the positive terminal 120 and the negative terminal 130 of the adjacent batteries 100, a break inducing part 40 that causes a break in the conduction part 10, and a resin sealing member 50. The conduction part 10 has a first member 11 made of the same first metal (aluminum in the first embodiment) as the positive terminal 120, and a second member 21 made of the same second metal (copper in the first embodiment) as the negative terminal 130. The first member 11 and the second member 21 are joined together.

The first member 11 is a pressed aluminum plate and consists of a flat plate portion 14 and a first housing portion 13. The flat plate portion 14 is in the form of a flat plate extending in the long-side direction BH and the short-side direction CH, and its exterior is rectangular. The first housing portion 13 protrudes from the flat plate portion 14 to the upper side AH1 in the height direction AH, on the other side BH2 in the long-side direction BH, and is in the form of a rectangular tube with a bottom, which opens at the lower side AH2 and is closed at the upper side AH1. A housing space SA in the shape of a rectangular parallelepiped is formed between the first housing portion 13 and a second housing portion 23 of the second member 21 that will be described below, and the break inducing part 40 is housed in the housing space SA. A rectangular encircling portion of the first housing portion 13 that is located on the lower side AH2 in the height direction AH provides a first seal portion 18 hermetically joined to the resin sealing member 50. Details of the first seal portion 18 will be described below.

The flat plate portion 14 has a first connecting portion 15, a first seal portion 16, and a first joining portion 17. In the first embodiment, the portions of the first member 11 other than the first connecting portion 15, i.e., the first housing portion 13 described above, the first seal portion 16, and the first joining portion 17 constitute a first non-connecting portion 12. The first connecting portion 15 is located on one side BH1 in the long-side direction BH, and is in the shape of a rectangular plate extending in the long-side direction BH and the short-side direction CH. The first connecting portion 15 is welded to the positive electrode top plate 121 of the positive terminal 120 of the battery 100.

The first joining portion 17 is a rectangular encircling or frame-like portion located on the other side BH2 in the long-side direction BH. The first joining portion 17 is welded to a second joining portion 27 of the second member 21 that will be described below to form a joint 37 comprising the first joining portion 17 and the second joining portion 27. The joint 37 conductively connects the first non-connecting portion 12 of the first member 11 and a second non-connecting portion 22 of the second member 21 that will be described below. In the first embodiment, the joint 37 provides an expected breaking portion 35. In the conduction part 10, the expected breaking portion 35 (the joint 37) is located between the first connecting portion 15 of the first member 11 and the second connecting portion 25 of the second member 21, and the first connecting portion 15 and the second connecting portion 25 are in conduction with each other through the expected breaking portion 35. Thus, when the expected breaking portion 35 breaks as described below, the connection between the first connecting portion 15 and the second connecting portion 25 becomes non-conductive.

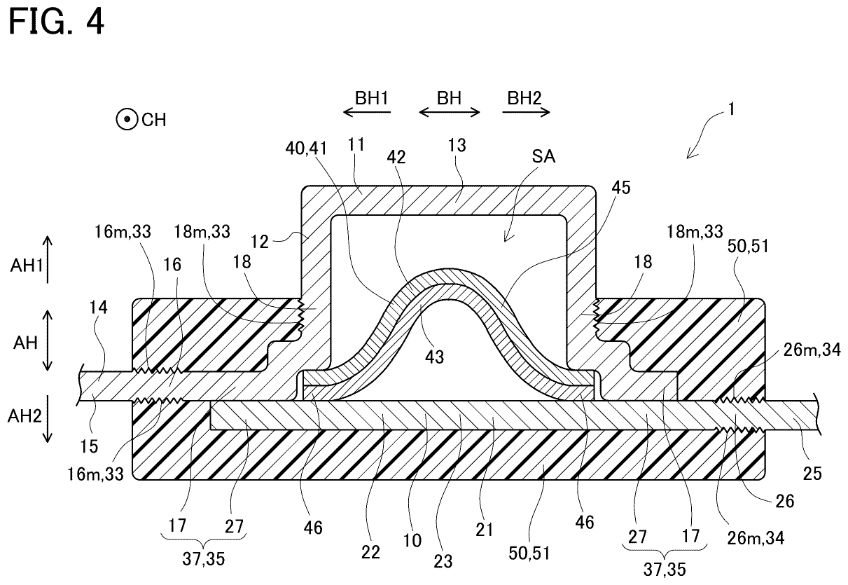

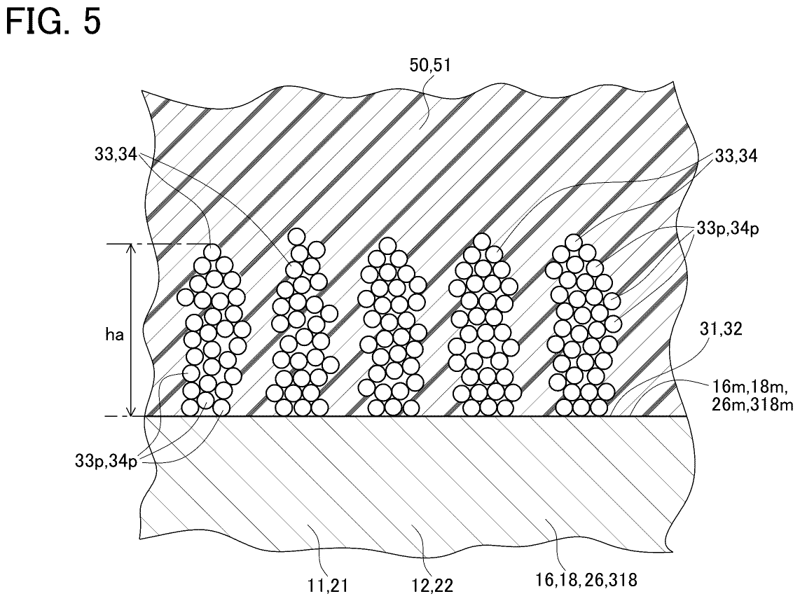

The first seal portion 16 is located between the first connecting portion 15 and the first joining portion 17, and is in the shape of a rectangular plate having a dimension in the short-side direction CH longer than that in the long-side direction BH. The first seal portion 16 of the flat plate portion 14 and the first seal portion 18 of the first housing portion 13 described above are each covered with the resin sealing member 50 and are hermetically joined to the resin sealing member 50. The first seal portion 16 of the flat plate portion 14 has a surrounding first roughened seal surface 16m (see FIG. 4 and FIG. 5) over the entire circumference orthogonal to the long-side direction BH. On the other hand, the first seal portion 18 of the first housing portion 13 has a surrounding first roughened seal surface 18m (see FIG. 4 and FIG. 5) on its outer side over the entire circumference orthogonal to the height direction AH.

The first roughened seal surfaces 16m, 18m are nano-level (nano-order) roughened surfaces. As shown in FIG. 5, nano-level first nanocolumns 33 formed by joining first particles 33p derived from the metal that forms the first member 11 together like strings of beads into the form of columns and having a height ha of 50 nm or more and less than 1000 nm stand together in large numbers on the first roughened seal surfaces 16m, 18m. In the first embodiment, the height ha of each first nanocolumn 33 is approximately 200 nm. The metal that forms the first member 11 is aluminum, as described above, and the first nanocolumn 33 is made up of the first particles 33p of aluminum and aluminum oxide.

The second member 21 is a rectangular copper plate extending in the long-side direction BH and the short-side direction CH. The second member 21 has the second housing portion 23, the second connecting portion 25, a second seal portion 26, and the second joining portion 27. In the first embodiment, the portions of the second member 21 other than the second connecting portion 25, i.e., the second housing portion 23, the second seal portion 26, and the second joining portion 27, constitute the second non-connecting portion 22. The second housing portion 23 is in the shape of a rectangular plate extending in the long-side direction BH and the short-side direction CH, and the housing space SA that contains the break inducing part 40 is formed between the second housing portion 23 and the first housing portion 13 of the first member 11, as described above.

The second connecting portion 25 is located on the other side BH2 in the long-side direction BH and is in the shape of a rectangular plate extending in the long-side direction BH and the short-side direction CH. The second connecting portion 25 is welded to the negative electrode top plate 131 of the negative terminal 130 of the battery 100. The second joining portion 27 is a rectangular encircling or frame-like portion located on the other side BH2 in the long-side direction BH, and is welded to the first joining portion 17 of the first member 11 to form the joint 37 (that also serves as the expected breaking portion 35 in the first embodiment), as described above.

The second seal portion 26 is located between the second connecting portion 25 and the second joining portion 27, and is in the shape of a rectangular plate having a dimension in the short-side direction CH longer than that in the long-side direction BH. The second seal portion 26 is covered with the resin sealing member 50 and is hermetically joined to the resin sealing member 50. The second seal portion 26 has a surrounding second roughened seal surface 26m (see FIG. 4 and FIG. 5) over the entire circumference orthogonal to the long-side direction BH. The second roughened seal surfaces 26m is also a nano-level roughened surface. As shown in FIG. 5, nano-level second nanocolumns 34 formed by joining second particles 34p derived from the metal that forms the second member 21 together like strings of beads into the form of columns and having a height ha of 50 nm or more and less than 1000 nm stand together in large numbers on the second roughened seal surface 26m. In the first embodiment, the height ha of each second nanocolumn 34 is approximately 200 nm. The metal that forms the second member 21 is copper, as described above, and the second nanocolumn 34 is made up of the second particles 34p of copper and copper oxide.

Next, the break inducing part 40 will be described. In the first embodiment, the break inducing part 40 is provided by a bimetal member 41. The bimetal member 41 is made of a clad material having two types of metal plates (a first metal plate 42 and a second metal plate 43) with different thermal expansion coefficients laminated together in the thickness direction. Specifically, the bimetal member 41 has a first metal plate 42 with a low coefficient of thermal expansion located on the outside (the upper side AH1) and a second metal plate 43 with a high coefficient of thermal expansion located on the inside (the lower side AH2). In the first embodiment, a metal plate made of Ni—Fe alloy is used as the first metal plate 42, and a metal plate made of Ni—Mn—Fe alloy is used as the second metal plate 43.

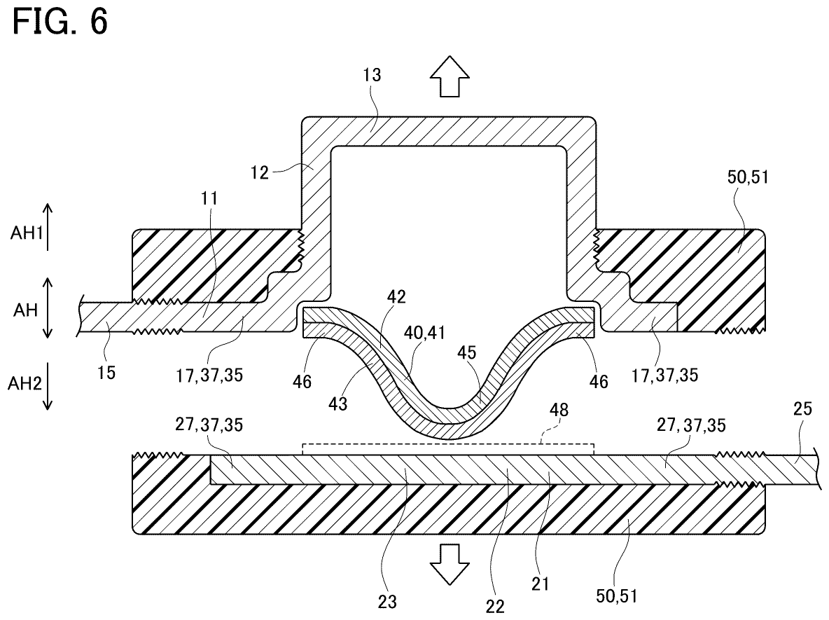

The bimetal member 41 consists of a semi-cylindrical portion 45 that has a semi-cylindrical shape with an axis extending in the short-side direction CH and is deformable to be reversed with a click, and a pair of ear portions (end portions) 46 located on one side BH1 and the other side BH2 of the semi-cylindrical portion 45 in the long-side direction BH and extending in the short-side direction CH (see FIG. 4). The ear portions 46 are sandwiched between the first member 11 and the second member 21 and fixed to the conduction part 10. Thus, the bimetal member 41 (the break inducing part 40) is fixed to the conduction part 10. An insulating member 48 made of an insulating ceramic (e.g., alumina) may be interposed between the bimetal member 41 and the second member 21, as indicated by a dashed line in FIG. 6, so as to insulate the bimetal member 41 and the second member 21 from each other. An insulating member (not shown) may also be interposed between the ear portions 46 of the bimetal member 41 and the first member 11 to insulate the bimetal member 41 and the first member 11 from each other.

The bimetal member 41 deforms to be reversed with a click when its own temperature rises to a level equal to or higher than the operating temperature Ta (Ta=130° C. in the first embodiment) (see FIG. 6). Then, the bimetal member 41 breaks the expected breaking portion 35 of the conduction part 10 and makes the connection between the first connecting portion 15 and the second connecting portion 25 of the conduction part 10 non-conductive. Specifically, the semi-cylindrical portion 45 that has protruded semi-cylindrically outward (to the upper side AH1) is deformed to protrude semi-cylindrically inward (to the lower side AH2) due to the temperature rise described above. The semi-cylindrical portion 45 then presses the second member 21 to the lower side AH2. Meanwhile, the pair of ear portions 46 of the bimetal member 41 each presses the first member 11 to the upper side AH1. This causes a break in the expected breaking portion 35 (joint 37). The break creates a clearance between the first joining portion 17 and the second joining portion 27, so that the connection between the first non-connecting portion 12 and the second non-connecting portion 22 becomes non-conductive, and the connection between the first connecting portion 15 and the second connecting portion 25 also becomes non-conductive.

Next, the resin sealing member 50 will be described. The resin sealing member 50 generally has an external shape of a rectangular parallelepiped, and hermetically covers a portion of the conduction part 10 to hermetically seal the joint 37 of the conduction part 10. The resin sealing member 50 is made of a resin material 51 that includes a thermoplastic resin, a thermoplastic elastomer, and a fibrous filler. In the first embodiment, the thermoplastic resin is polyphenylene sulfide (PPS), the thermoplastic elastomer is a thermoplastic polyurethane elastomer, and the fibrous filler is glass fiber. The resin sealing member 50 is insert-molded as described below.

The resin sealing member 50 covers the first seal portion 16, the first joining portion 17, and only the first seal portion 18 of the first housing portion 13, of the first non-connecting portion 12 of the first member 11, and is hermetically joined to the first seal portions 16, 18. The resin sealing member 50 also covers the second seal portion 26, the second joining portion 27, and the entire second housing portion 23 of the second non-connecting portion 22 of the second member 21, and is hermetically joined to the second seal portion 26.

Specifically, the resin sealing member 50 is hermetically joined to the first roughened seal surfaces 16m, 18m, respectively, with the resin material 51 that forms the resin sealing member 50 filling gaps between the first nanocolumns 33 standing numerously on the first roughened seal surfaces 16m, 18m of the first seal portions 16, 18. This effectively reduces or eliminates the possibility that air and moisture enter the resin sealing member 50 from the boundary between the first member 11 and the resin sealing member 50 and contact the joint 37. The resin sealing member 50 is also hermetically joined to the second roughened seal surface 26m with the resin material 51 that forms the resin sealing member 50 filling gaps between the above-mentioned second nanocolumns 34 standing numerously on the second roughened seal surface 26m of the second seal portion 26. This effectively reduces or eliminates the possibility that air and moisture enter the resin sealing member 50 from the boundary between the second member 21 and the resin sealing member 50 and contact the joint 37.

In the bus bar 1 of the first embodiment, the break inducing part 40 deforms when the temperature of the break inducing part 40 rises to the operating temperature Ta or higher, and breaks the expected breaking portion 35 of the conduction part 10, causing non-conduction between the first connecting portion 15 and the second connecting portion 25 of the conduction part 10. Thus, the bus bar 1 itself can cut off electrical connection between the batteries 100 conducted via the bus bar 1. Furthermore, in the first embodiment, the break inducing part 40 has the bimetal member 41; therefore, the bimetal member 41 deforms to be reversed with a click when the temperature of the bimetal member 41 rises to the operating temperature Ta or higher, so that it can break the expected breaking portion 35 of the conduction part 10.

In the first embodiment, the positive terminal 120 made of the first metal (aluminum in the first embodiment) of one of two adjacent batteries 100 and the negative terminal 130 made of the second metal (copper in the first embodiment) of the other battery 100 are connected by the bus bar 1. Meanwhile, the conduction part 10 of the bus bar 1 is formed by joining the first member 11 made of the same first metal as the positive terminal 120 and the second member 21 made of the same second metal as the negative terminal 130. Thus, the first member 11 of the bus bar 1 can be easily connected to the positive terminal 120 of the one battery 100 by welding, for example, and the second member 21 of the bus bar 1 can be easily connected to the negative terminal 130 of the other battery 100 by welding, for example.

In the first embodiment, since the first member 11 and the second member 21 are made of different metals, galvanic corrosion may occur between the first joining portion 17 and the second joining portion 27 of the joint 37 at which the first and second members 11, 21 are joined. In the bus bar 1, however, the joint 37 is hermetically sealed with the resin sealing member 50. Therefore, air and moisture are prevented from contacting the joint 37, and corrosion is less likely or unlikely to occur between the first joining portion 17 and the second joining portion 27.

In the first embodiment, the nano-level first roughened seal surfaces 16m, 18m on which the above-mentioned first nanocolumns 33 stand numerously are formed on the first non-connecting portion 12 of the first member 11, and the nano-level second roughened seal surface 26m on which the above-mentioned second nanocolumns 34 stand numerously is formed on the second non-connecting portion 22 of the second member 21. Then, the resin sealing member 50 is hermetically joined to the first roughened seal surfaces 16m, 18m with the resin material 51 filling gaps between the first nanocolumns 33 standing numerously on the first roughened seal surfaces 16m, 18m, and the resin sealing member 50 is hermetically joined to the second roughened seal surface 26m with the resin material 51 filling gaps between the second nanocolumns 34 standing numerously on the second roughened seal surface 26m, thereby to hermetically seal the joint 37. In this manner, the joint 37 can be sealed with particularly high airtightness, and corrosion can be more effectively curbed at the joint 37.

Next, a method of manufacturing the bus bar 1 described above will be described. First, the first member 11, the second member 21, and the bimetal member 41 are prepared. Then, while placing the bimetal member 41 between the first housing portion 13 of the first member 11 and the second housing portion 23 of the second member 21, the first joining portion 17 of the first member 11 and the second joining portion 27 of the second member 21 are superposed on each other and welded together over the entire circumference. As a result, the conduction part 10 that contains the break inducing part 40 is formed.

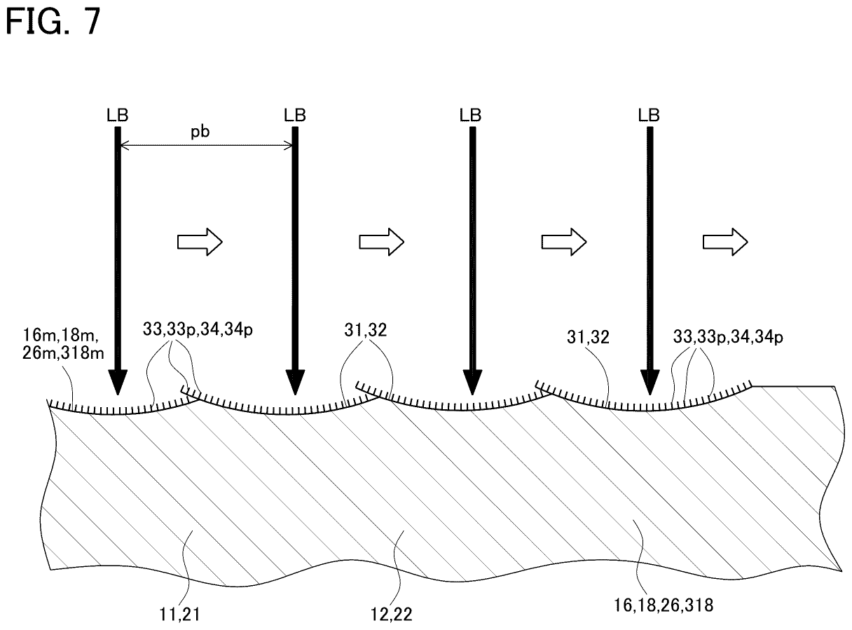

Then, the surface roughening treatment is applied to the conduction part 10 described above, to form the nano-level first roughened seal surfaces 16m, 18m on the first seal portions 16, 18 of the first member 11 and the nano-level second roughened seal surface 26m on the second seal portion 26 of the second member 21 (see FIG. 7). Specifically, a pulsed laser beam LB is intermittently applied to the first seal portions 16, 18 of the first member 11 while shifting the irradiation position to form the first roughened seal surfaces 16m, 18m in which numerous first bowl-shaped recesses 31 on which the first nanocolumns 33 stand numerously are arranged while partially overlapping. The laser irradiation conditions are set as follows: the wavelength is 1064 nm, the peak power is 5 kW, the pulse width is 150 ns, the pitch pb is 75 μm, and the spot diameter is 80 μm.

In the portions of the first seal portions 16, 18 that are irradiated with the pulsed laser beam LB, the first metal (aluminum in the first embodiment) near the surface melts and further turns into vapor. Then, as the temperature of the vapor decreases, the vapor becomes the first particles 33p of aluminum and aluminum oxide, which are then deposited on the first bowl-shaped recesses 31. By intermittently applying the pulsed laser beam LB to the first seal portions 16, 18 while shifting the irradiation position, the first particles 33p are deposited and joined together like strings of beads into the form of columns, to form the first nanocolumns 33 standing together in large numbers.

A pulsed laser beam LB is also intermittently applied to the second seal portion 26 of the second member 21 while shifting the irradiation position to form the second roughened seal surface 26m in which numerous second bowl-shaped recesses 32 on which the second nanocolumns 34 stand numerously are arranged while partially overlapping (see FIG. 7). The laser irradiation conditions are set as follows: the wavelength is 1064 nm, the peak power is 20 kW, the pulse width is 50 ns, the pitch pb is 60 μm, and the spot diameter is 75 μm. In the portions of the second seal portion 26 that are irradiated with the pulsed laser beam LB, the second metal (copper in the first embodiment) near the surface melts and further turns into vapor. Then, as the temperature of the vapor decreases, the vapor becomes the second particles 34p of copper and copper oxide, which are then deposited on the second bowl-shaped recesses 32. By intermittently applying the pulsed laser beam LB to the second seal portion 26 while shifting the irradiation position, the second particles 34p are deposited and joined together like strings of beads into the form of columns, to form the second nanocolumns 34 standing together in large numbers.

Then, the resin sealing member 50 is insert-molded. Specifically, using a molding die (not shown) having an upper die and a lower die, the conduction part 10, etc. after roughening as described above is placed at a predetermined position of the lower die, and then the molding die is closed. Thereafter, the molten resin of the resin material 51 is injected into a cavity so that the cavity is filled with the molten resin. At this time, the molten resin of the resin material 51 fills gaps between the first nanocolumns 33 standing numerously on the first roughened seal surfaces 16m, 18m of the first seal portions 16, 18 of the first member 11 and gaps between the second nanocolumns 34 standing numerously on the second roughened seal surface 26m of the second seal portion 26 of the second member 21 (see FIG. 5). Then, the resin sealing member 50 hermetically joined to the first roughened seal surfaces 16m, 18m of the first member 11 and the second roughened seal surface 26m of the second member 21 is formed. The resin seal member 50 hermetically seals the joint 37 of the conduction part 10. In this manner, the bus bar 1 is completed.

### Second Embodiment

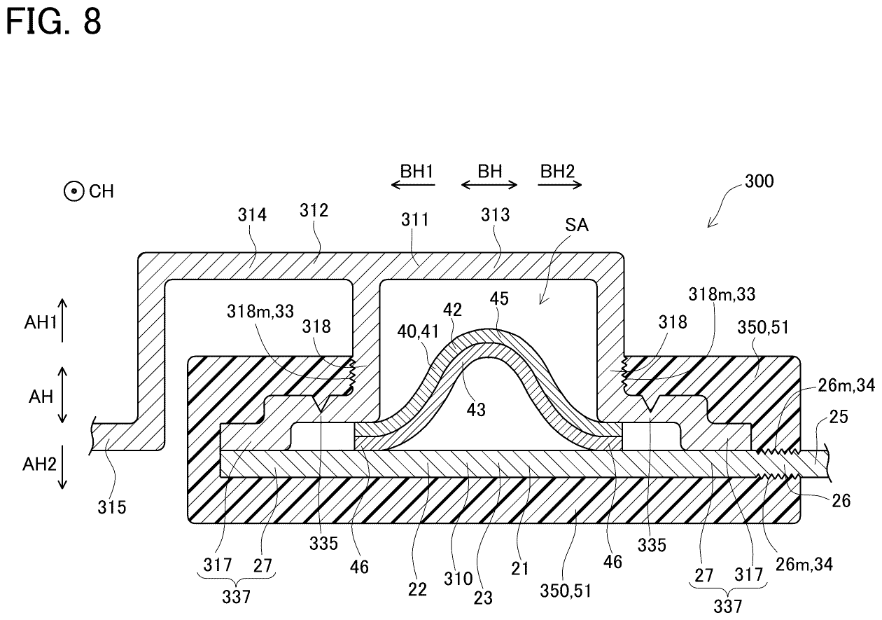

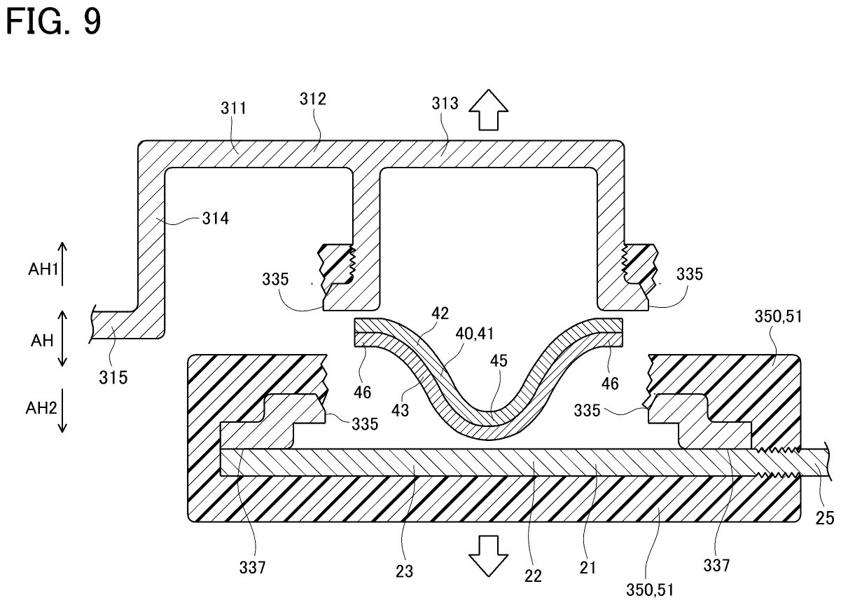

Next, a second embodiment will be described (see FIG. 8 and FIG. 9). Description of portions similar to those of the first embodiment will be omitted or simplified. In the bus bar 1 of the first embodiment, the joint 37 of the conduction part 10 is the expected breaking portion 35 that breaks when the temperature of the bus bar 1 becomes high. In contrast, in a bus bar (one example of the inter-device conduction member of the disclosure) 300 of the second embodiment, a notched portion provided in a first member 311 of a conduction part 310 provides an expected breaking portion 335.

The bus bar 300 of the second embodiment consists of the conduction part 310 having the first member 311 and the second member 21, the break inducing part 40 comprising the bimetal member 41, and a resin sealing member 350 (see FIG. 8). The first member 311 of the conduction part 310 is formed of a first metal (specifically, aluminum) like the first member 11 of the first embodiment, but is different in form from the first member 11. On the other hand, the second member 21 is similar to that of the first embodiment. The first member 311 of the second embodiment consists of a first connecting portion 315 and a first non-connecting portion 312, and the first non-connecting portion 312 has an extended portion 314, a first housing portion 313, a notched portion (expected breaking portion) 335, and a first joining portion 317.

The first connecting portion 315 is similar to the first connecting portion 15 of the first embodiment and is connected to the positive terminal 120 of the battery 100. The first housing portion 313 is similar to the first housing portion 13 of the first embodiment, and houses the break inducing part 40 in the housing space SA defined between the first housing portion 313 and the second housing portion 23 of the second member 21. The first housing portion 313 has a first seal portion 318 including a nano-level first roughened seal surface 318m (see FIG. 5), like the first seal portion 18 of the first embodiment, and the first roughened seal surface 318m is hermetically joined to the resin sealing member 350. The extended portion 314 extends from the first connecting portion 315 to the first housing portion 313 and connects the first connecting portion 315 and the first housing portion 313.

The first joining portion 317 is a rectangular encircling or frame-like portion like the first joining portion 17 of the first embodiment, and is welded to the second joining portion 27 of the second member 21 to form a joint 337 comprising the first joining portion 317 and the second joining portion 27. However, in the second embodiment, the joint 337 is not used as the expected breaking portion and does not break when the temperature of the bus bar 300 becomes high. In the second embodiment, the expected breaking portion 335 is a notched portion (a portion where a V-shaped groove is formed) provided between the first housing portion 313 and the first joining portion 317, which is thinner and easier to break than the other portions of the first member 311. In the conduction part 10, the expected breaking portion 335 is located between the first connecting portion 315 of the first member 311 and the second connecting portion 25 of the second member 21, and is conductively connected to the first connecting portion 315 and the second connecting portion 25.

The break inducing part 40 comprises the bimetal member 41, as in the first embodiment. The bimetal member 41 is deformed to be reversed with a click (see FIG. 9) when its own temperature rises to a level equal to or higher than the operating temperature Ta (specifically, Ta=130° C.), as described above. Then, in the second embodiment, breakage occurs in the notched portion (expected breaking portion) 335 of the conduction part 310 because the notched portion (expected breaking portion) 335 has lower strength and is easier to break than the joint 337. As a result, the connection between the first connecting portion 315 and the second connecting portion 25 of the conduction part 310 becomes non-conductive.

The resin sealing member 350 is made of the resin material 51 of the first embodiment described above, and its exterior is generally in the shape of a rectangular parallelepiped. The resin sealing member 350 hermetically covers a portion of the conduction part 310 to hermetically seal the joint 337. Specifically, the resin sealing member 350 covers the first joining portion 317, the expected breaking portion 335 comprising the notched portion, and the first seal portion 318, of the first member 311, and is hermetically joined to the first seal portion 318. The resin sealing member 350 also covers the second seal portion 26, the second joining portion 27, and the second housing portion 23 of the second member 21, and is hermetically joined to the second seal portion 26.

In the bus bar 300 of the second embodiment, too, the break inducing part 40 deforms when the temperature of the break inducing part 40 rises to the operating temperature Ta or higher, and breaks the expected breaking portion 335 of the conduction part 310, making the connection between the first connecting portion 315 and the second connecting portion 25 of the conduction part 310 non-conductive. Thus, the bus bar 300 itself can cut off electrical connection between the batteries 100 conducted via the bus bar 300. Other portions similar to those of the first embodiment yield substantially the same effects as those provided in the first embodiment.

### Third Embodiment

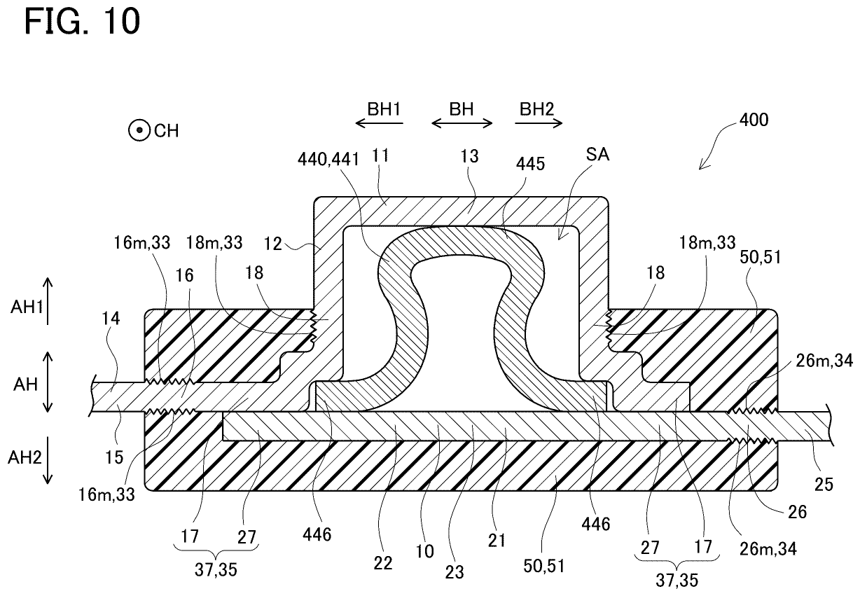

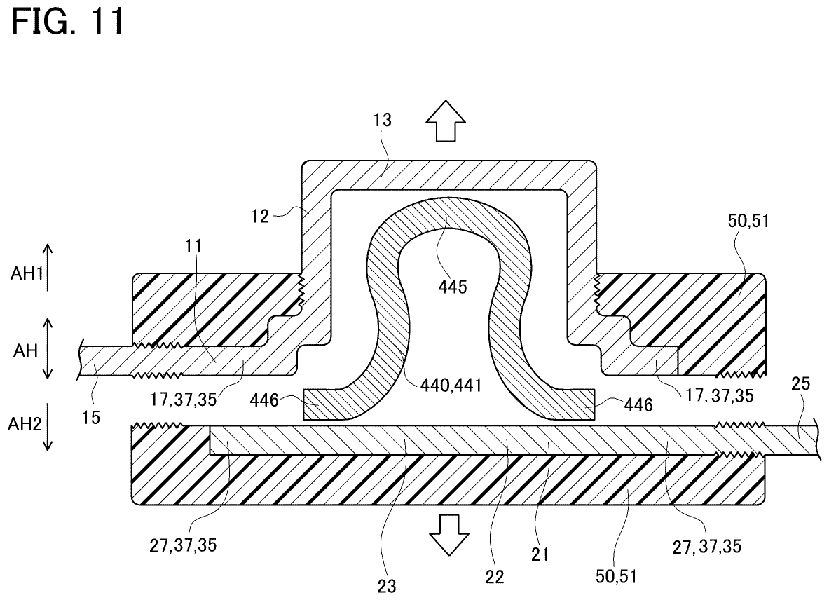

Next, a third embodiment will be described (FIG. 10 and FIG. 11). Description of portions similar to those of the first or second embodiment will be omitted or simplified. In the bus bars 1, 300 of the first and second embodiments, the bimetal member 41 is used to form the break inducing part 40. In contrast, in a bus bar (one example of the inter-device conduction member of the disclosure) 400 of the third embodiment, a shape memory alloy member 441 is used to form a break inducing part 440.

The bus bar 400 of the third embodiment consists of the conduction part 10, the break inducing part 440, and the resin sealing member 50 (see FIG. 10). The conduction part 10 and the resin sealing member 50 are similar to those of the first embodiment. On the other hand, in the third embodiment, the break inducing part 440 has a shape memory alloy member 441 made of a shape memory alloy. The shape memory alloy member 441 in its original form (see FIG. 11) consists of a semi-cylindrical portion 445 with its axis extending in the short-side direction CH, and a pair of ear portions (end portions) 446 located on one side BH1 and the other side BH2, respectively, of the semi-cylindrical portion 445 in the long-side direction BH and extending in the short-side direction CH. In the bus bar 400 (see FIG. 10), the shape memory alloy member 441, which is pressed down in the height direction AH, is housed in the housing space SA of the conduction part 10. The pair of ear portions 446 are sandwiched between the first member 11 and the second member 21 and fixed to the conduction part 10.

The shape memory alloy member 441 deforms to return to its original shape (see FIG. 11) when its own temperature rises to a level equal to or higher than the operating temperature Ta (Ta=130° C. in the third embodiment) that is the transformation point. Then, the shape memory alloy member 441 breaks the expected breaking portion 35 of the conduction part 10 and make the connection between the first connecting portion 15 and the second connecting portion 25 of the conduction part 10 non-conductive. Specifically, the semi-cylindrical portion 445, which has been pressed down in the height direction AH, is deformed to its original semi-cylindrical shape due to the temperature rise described above. Then, the semi-cylindrical portion 445 presses the first member 11 to the upper side AH1. Meanwhile, the pair of ear portions 446 of the shape memory alloy member 441 each press the second member 21 to the lower side AH2. As a result, the joint 37 (the expected breaking portion 35) breaks as in the first embodiment, and the connection between the first connecting portion 15 and the second connecting portion 25 becomes non-conductive.

In the bus bar 400 of the third embodiment, too, the break inducing part 440 deforms when the temperature of the break inducing part 440 rises to the operating temperature Ta or higher, causing the expected breaking portion 35 of the conduction part 10 to break and making the connection between the first connecting portion 15 and the second connecting portion 25 of the conduction part 10 non-conductive. Thus, the bus bar 400 itself can cut off electrical connection between the batteries 100 conducted via the bus bar 400. In the third embodiment, in particular, the break inducing part 440 has the shape memory alloy member 441; therefore, when the temperature of the shape memory alloy member 441 rises to the operating temperature Ta or higher, the shape memory alloy member 441 can deform to return to its original shape and break the expected breaking portion 35 of the conduction part 10. Other portions similar to those of the first or second embodiment yield substantially the same effects as those provided in the first or second embodiment.

### Fourth Embodiment

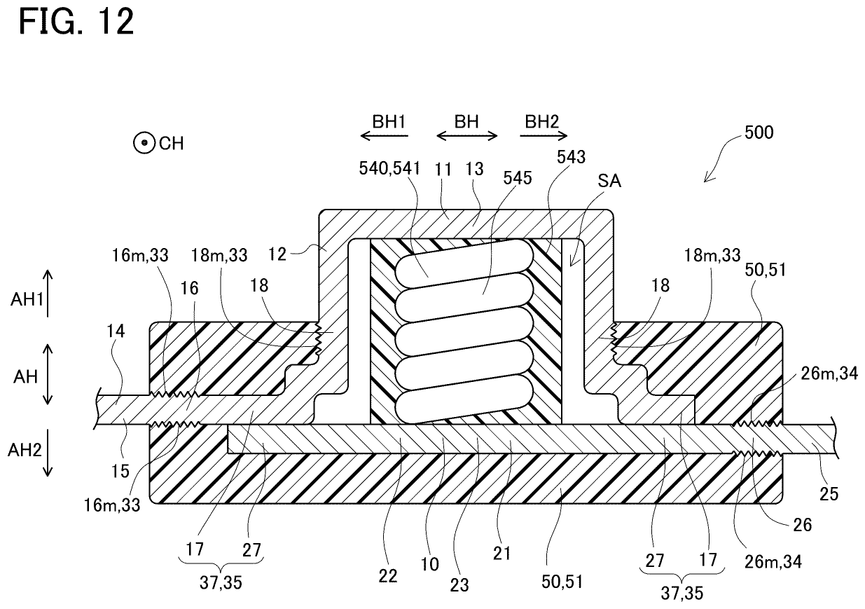

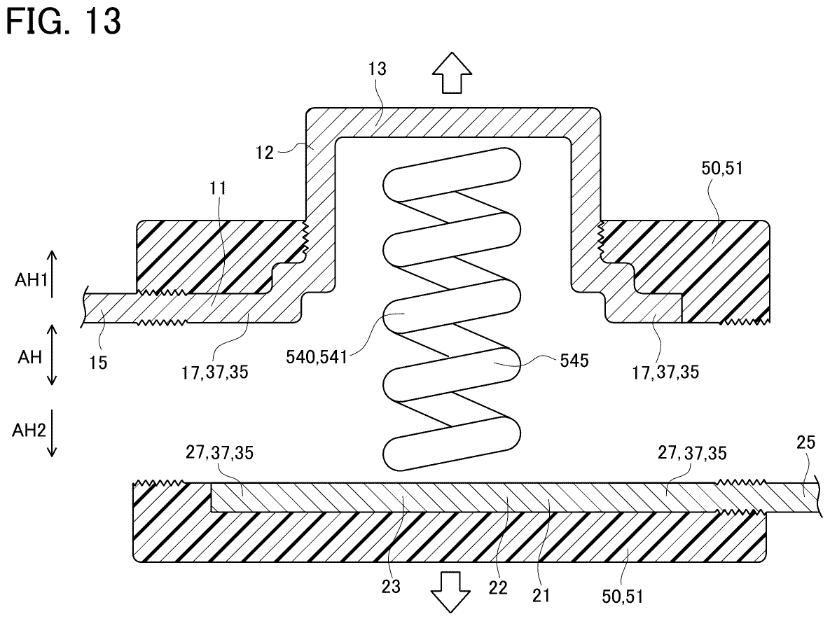

Next, a fourth embodiment will be described (FIG. 12 and FIG. 13). Description of portions similar to those of any of the first to third embodiments will be omitted or simplified. In the bus bars 1, 300 of the first and second embodiments, the bimetal member 41 is used to form the break inducing part 40. In the bus bar 400 of the third embodiment, the shape memory alloy member 441 is used to form the break inducing part 440. In contrast, in a bus bar (one example of the inter-device conduction member of the disclosure) 500 of the fourth embodiment, a temperature-sensitive structure 541 having an elastic member 545 and a fixing member 543 that fixes the elastic member 545 is used to form a break inducing part 540.

The bus bar 500 of the fourth embodiment consists of the conduction part 10, the break inducing part 540, and the resin sealing member 50 (see FIG. 12). The conduction part 10 and the resin sealing member 50 are similar to those of the first embodiment. On the other hand, in the fourth embodiment, the break inducing part 540 has the temperature-sensitive structure 541 comprising the elastic member 545 and the fixing member 543. The break inducing part 540 is housed in the housing space SA of the conduction part 10. The elastic member 545 is a coil spring with its axis extending in the height direction AH, and is normally held by the fixing member 543 in a compressed state in which it is compressed or contracted in the height direction AH. In the fourth embodiment, the fixing member 543 is made of a thermoplastic resin. The fixing member 543 may also be made of a low-melting-point metal. The fixing member 543 is in the shape of a column with an outer diameter larger than that of the elastic member 545, and covers entirely the radially outer side of the elastic member 545. The fixing member 543 is joined at its lower end to the second housing portion 23 of the second member 21 of the conduction part 10. Thus, the temperature-sensitive structure 541 (the break inducing part 540) comprising the fixing member 543 and the elastic member 545 is fixed to the conduction part 10.

The fixing member 543 softens and releases the elastic member 545 held by the fixing member 543 when its own temperature rises to a level equal to or higher than the operating temperature Ta (Ta=130° C. in the fourth embodiment) that is the softening temperature (see FIG. 13). Then, the elastic member 545 breaks the expected breaking portion 35 of the conduction part 10 to make the connection between the first connecting portion 15 and the second connecting portion 25 of the conduction part 10 non-conductive. Specifically, when the fixing member 543 softens, the elastic member 545 in the form of the compressed coil spring expands in the height direction AH. Then, the elastic member 545 presses the first member 11 to the upper side AH1, and presses the second member 21 to the lower side AH2. As a result, the joint 37 (the expected breaking portion 35) is broken in the same manner as in the first embodiment, and the connection between the first connecting portion 15 and the second connecting portion 25 becomes non-conductive.

The bus bar 500 of the fourth embodiment is formed by the following method. The second member 21 is prepared, the elastic member 545 is placed at a predetermined position on the second housing portion 23 of the second member 21, and the elastic member 545 is compressed. In this state, insert molding is performed to form the fixing member 543 that fixes the elastic member 545 in the compressed state. In this manner, the break inducing part 540 is formed on the second housing portion 23 of the second member 21. Then, the first joining portion 17 of the first member 11 that has been separately prepared is superposed on the second joining portion 27 of the second member 21, and these portions 17, 27 are welded together to form the conduction part 10 with the break inducing part 540 housed inside. Thereafter, the bus bar 400 is produced in the same manner as in the first embodiment.

In the bus bar 500 of the fourth embodiment, too, the break inducing part 540 deforms when the temperature of the break inducing part 540 rises to the operating temperature Ta or higher, to break the expected breaking portion 35 of the conduction part 10 and make the connection between the first connecting portion 15 and the second connecting portion 25 of the conduction part 10 non-conductive. Thus, the bus bar 500 itself can cut off electrical connection between the batteries 100 conducted via the bus bar 500. In the fourth embodiment, in particular, the break inducing part 540 has the temperature-sensitive structure 541 comprising the elastic member 545 and the fixing member 543; therefore, when the temperature of the fixing member 543 rises to the operating temperature Ta or higher, the elastic member 545 held by the fixing member 543 is released and is deformed to return to its original shape, so that it can break the expected breaking portion 35 of the conduction part 10. Other portions similar to those of any of the first to third embodiments yield substantially the same effects as those provided in any of the first to third embodiments.

While the disclosure has been described in the light of the first to fourth embodiments, it is to be understood that the disclosure is not limited to the first to fourth embodiments, but may be applied by making changes as needed, without departing from the principle of the disclosure. For example, the lithium-ion secondary battery has been illustrated by way of example as the power storage device in the first to fourth embodiments, but the power storage device is not limited to this. Examples of the power storage device include secondary batteries, such as a sodium-ion secondary battery, and a calcium-ion secondary battery, and capacitors, such as a lithium-ion capacitor.

In the first to fourth embodiments, the first member 11, 311 and the second member 21 are welded together to form the conduction part 10, 310, but the method of joining the first member and the second member is not limited to this. Examples of the method of joining the first member and the second member include fastening using bolts and nuts, FSW (friction stir welding), caulking, and riveting. While the joint 37 of the conduction part 10 serves as the expected breaking portion 35 in the first, third, and fourth embodiments, and the notched portion provided in the first member 311 of the conduction part 310 serves as the expected breaking portion 335 in the second embodiment, the expected breaking portion is not limited to these. For example, a notched or thin-walled portion may be provided in the second member of the conduction part and used as the expected breaking portion. It is also possible to provide notched or thin-walled portions in the first member and the second member, respectively, and to use each of these portions as an expected breaking portion (i.e., to provide two or more expected breaking portions).

While the bus bars 1, 300, 400, 500 that connect adjacent batteries 100 in series are illustrated by way of example in the first to fourth embodiments, the disclosure may be applied to bus bars that connect batteries in parallel. In this case, a bus bar that connects positive terminals 120 of the batteries 100 preferably has a first member and a second member that are formed of the same aluminum as the positive terminals 120, and a bus bar that connects negative terminals 130 of the batteries 100 preferably has a first member and a second member that are formed of the same copper as the negative terminals 130.

While the resin sealing member 50, 350 is configured to cover only a part of the first housing portion 13, 313 of the first member 11, 311 on the lower side AH2 in the first to fourth embodiments, the resin sealing member 50, 350 may be configured to cover the entire first housing portion 13, 313.

### REFERENCE SIGNS LIST

1, 300, 400, 500 Bus bar (Inter-device conduction member)
10, 310 Conduction part
11, 311 First member
12, 312 First non-connecting portion
15, 315 First connecting portion
16, 18, 318 First seal portion
16m, 18m, 318m First roughened seal surface
17, 317 First joining portion
21 Second member
22 Second non-connecting portion
25 Second connecting portion
26 Second seal portion
26m Second roughened seal surface
27 Second joining portion
33 First nanocolumn
33p First particle
34 Second nanocolumn
34p Second particle
35 Expected breaking portion (joint)
335 Expected breaking portion (notched portion)
37, 337 Joint
40, 440, 540 Break inducing part
41 Bimetal member
441 Shape memory alloy member
541 Temperature-sensitive structure
543 Fixing member
545 Elastic member
50, 350 Resin sealing member
51 Resin material
100 Battery (Power storage device)
120 Positive terminal (electrode terminal)
130 Negative terminal (electrode terminal)
Ta Operating temperature
ha Height

What is claimed is:

1. An inter-device conduction member that conducts electricity between an electrode terminal of a first power storage device and an electrode terminal of a second power storage device, the inter-device conduction member comprising:
a conduction part having a first connecting portion that connects to the electrode terminal of the first power storage device, a second connecting portion that connects to the electrode terminal of the second power storage device, and an expected breaking portion that is located between the first connecting portion and the second connecting portion and is conductively connected with the first connecting portion and the second connecting portion; and
a break inducing part configured to deform upon a temperature rise to a level equal to or higher than an operating temperature to break the expected breaking portion of the conduction part and make connection between the first connecting portion and the second connecting portion non-conductive.

2. The inter-device conduction member according to claim 1, wherein the conduction part has a first member comprising a first metal and comprising the first connecting portion and a first non-connecting portion other than the first connecting portion, a second member comprising a second metal different from the first metal and comprising the second connecting portion and a second non-connecting portion other than the second connecting portion, and a joint in which a part of the first non-connecting portion and a part of the second non-connecting portion are joined together and are conductively connected with each other.

3. The inter-device conduction member according to claim 2, further comprising a resin sealing member that hermetically seals the joint of the conduction part.

4. The inter-device conduction member according to claim 3, wherein:
the first non-connecting portion of the first member has a first roughened seal surface on which first nanocolumns formed by joining first particles derived from the first metal that forms the first member together like strings of beads into the form of columns and having a height of 50 nm or more stand numerously;
the second non-connecting portion of the second member has a second roughened seal surface on which second nanocolumns formed by joining second particles derived from the second metal that forms the second member together like strings of beads into the form of columns and having a height of 50 nm or more stand numerously; and
the resin sealing member hermetically seals the joint by being hermetically joined to the first roughened seal surface such that a resin material that forms the resin sealing member fills gaps between the first nanocolumns standing numerously on the first roughened seal surface, and by being hermetically joined to the second roughened seal surface such that the resin material fills gaps between the second nanocolumns standing numerously on the second roughened seal surface.

5. The inter-device conduction member according to claim 1, wherein the break inducing part has a bimetal member comprising a bimetal and configured to deform to be reversed with a click upon a temperature rise to a level equal to or higher than the operating temperature, causing the expected breaking portion of the conduction part to break.

6. The inter-device conduction member according to claim 2, wherein the break inducing part has a bimetal member comprising a bimetal and configured to deform to be reversed with a click upon a temperature rise to a level equal to or higher than the operating temperature, causing the expected breaking portion of the conduction part to break.

7. The inter-device conduction member according to claim 3, wherein the break inducing part has a bimetal member comprising a bimetal and configured to deform to be reversed with a click upon a temperature rise to a level equal to or higher than the operating temperature, causing the expected breaking portion of the conduction part to break.

8. The inter-device conduction member according to claim 4, wherein the break inducing part has a bimetal member comprising a bimetal and configured to deform to be reversed with a click upon a temperature rise to a level equal to or higher than the operating temperature, causing the expected breaking portion of the conduction part to break.

9. The inter-device conduction member according to claim 1, wherein the break inducing part has a shape memory alloy member comprising a shape memory alloy and configured to deform upon a temperature rise to a level equal to or higher than the operating temperature that is a transformation point, causing the expected breaking portion of the conduction part to break.

10. The inter-device conduction member according to claim 2, wherein the break inducing part has a shape memory alloy member comprising a shape memory alloy and configured to deform upon a temperature rise to a level equal to or higher than the operating temperature that is a transformation point, causing the expected breaking portion of the conduction part to break.

11. The inter-device conduction member according to claim 3, wherein the break inducing part has a shape memory alloy member comprising a shape memory alloy and configured to deform upon a temperature rise to a level equal to or higher than the operating temperature that is a transformation point, causing the expected breaking portion of the conduction part to break.

12. The inter-device conduction member according to claim 4, wherein the break inducing part has a shape memory alloy member comprising a shape memory alloy and configured to deform upon a temperature rise to a level equal to or higher than the operating temperature that is a transformation point, causing the expected breaking portion of the conduction part to break.

13. The inter-device conduction member according to claim 1, wherein:
the break inducing part has a temperature-sensitive structure including a fixing member comprising a thermoplastic resin or a low-melting-point metal, and an elastic member held in a compressed state by the fixing member; and
the temperature-sensitive structure is configured to release the elastic member held by the fixing member to break the expected breaking portion of the conduction part upon a temperature rise to a level equal to or higher than the operating temperature that is a softening temperature of the thermoplastic resin or a melting point of the low-melting-point metal.

14. The inter-device conduction member according to claim 2, wherein:
the break inducing part has a temperature-sensitive structure including a fixing member comprising a thermoplastic resin or a low-melting-point metal, and an elastic member held in a compressed state by the fixing member; and
the temperature-sensitive structure is configured to release the elastic member held by the fixing member to break the expected breaking portion of the conduction part upon a temperature rise to a level equal to or higher than the operating temperature that is a softening temperature of the thermoplastic resin or a melting point of the low-melting-point metal.

15. The inter-device conduction member according to claim 3, wherein:
the break inducing part has a temperature-sensitive structure including a fixing member comprising a thermoplastic resin or a low-melting-point metal, and an elastic member held in a compressed state by the fixing member; and
the temperature-sensitive structure is configured to release the elastic member held by the fixing member to break the expected breaking portion of the conduction part upon a temperature rise to a level equal to or higher than the operating temperature that is a softening temperature of the thermoplastic resin or a melting point of the low-melting-point metal.

16. The inter-device conduction member according to claim 4, wherein:
the break inducing part has a temperature-sensitive structure including a fixing member comprising a thermoplastic resin or a low-melting-point metal, and an elastic member held in a compressed state by the fixing member; and
the temperature-sensitive structure is configured to release the elastic member held by the fixing member to break the expected breaking portion of the conduction part upon a temperature rise to a level equal to or higher than the operating temperature that is a softening temperature of the thermoplastic resin or a melting point of the low-melting-point metal.
